(19) United States
(12) Patent Application Publication
(10) Pub. No.: US 2016/0012031 A1
(43) Pub. Date: Jan. 14, 2016

(54) TEMPLATE-BASED MESSAGE GENERATION TOOL

(71) Applicant: BANK OF AMERICA CORPORATION, CHARLOTTE, NC (US)

(72) Inventors: Raghavendran Narasimhan, Hyderabad (IN); Pankaj Kumar, Gurgaon (IN); Mohit Sharma, Gurgaon (IN); Monika V. Kapur, Gurgaon (IN); Nirmala Gayal, Gurgaon (IN)

(21) Appl. No.: 14/326,126

(22) Filed: Jul. 8, 2014

(51) Int. Cl. G06F 17/24; G06Q 40/00; G06F 3/0482; H04L 12/58; G06F 3/0484

(52) U.S. Cl. CPC G06F 17/248; H04L 51/046; G06F 3/04842; G06F 3/0482; G06F 17/243; G06Q 40/00

(57) ABSTRACT

Embodiments of the invention are directed to systems, methods and computer program products for use in financial systems, where message are automatically generated based on message templates. An exemplary apparatus is configured to access a click to launch tool that is configured to automatically generate messages based at least partially on one or more message templates. After selecting a message type presented within the click to launch tool, the system may receive information via a message template associated with the selected message type and related to a financial agreement. A message comprising the received information is automatically generated and sent the message to one or more entities associated with the financial agreement.

### BACKGROUND

Traditionally, when sending template-based correspondence, business personnel are required to go through a number manual steps for the purpose of generating messages, such as copying and pasting message templates into email messages and manually filling the information within the formatted templates. This task can be fairly time consuming. Therefore, a need exist for a means to seamlessly track accounts that have been placed on a temporary waiver and automate follow-up procedures with the requesting entities when the duration of the waivers have expired.

### BRIEF SUMMARY

Embodiments of the invention are directed to systems, methods, and computer program products for generating messages based on message templates in a financial institution system. An exemplary apparatus for generating messages based on message templates in a financial institution system may comprise a memory, a computing processor, and a module stored in the memory. The module may comprise instruction code executable by one or more computing processors and configured to cause the one or more computing processors to access a click to launch tool, the click to launch tool being configured to automatically generate messages based at least partially on one or more message templates. A message type to be presented within the click to launch tool may then be selected. The message type being associated with a selectable option indicating a type of message the click to launch tool is configured to generate. Information may be received via a message template associated with the selected message type, where the receive information is additionally related to a financial agreement. A message associated with the selected message type and comprising the received information may then be automatically generated, and the automatically generated message may be sent to one or more entities associated with the financial agreement.

In some embodiments, the module is further configured to cause one or more computing processors to store the click to launch tool in a storage location that is accessible by one or more authorized user devices.

In some embodiments, accessing the click to launch tool may further comprise the module being configured to cause one or more computing processors to present a graphical user interface (GUI) associated with the click to launch tool on a computing device display of a user.

In some embodiments, accessing the click to launch tool may further comprise the module being configured to customize the graphical user interface (GUI) associated with the click to launch tool presented on the computing device display of the user.

In some embodiments, selecting a message type presented within the click to launch tool further comprises the module being configured to present, on a display of a user's computing device, a message template associated with the selected message type.

In some embodiments, where the click to launch tool comprises an option to join one or more message templates.

In some embodiments, where the message type comprises at least one of an introduction message, a calculating pricing for letter or consent renewal message, a non-real estate due diligence needs list message, or a real estate due diligence needs list message.

In some embodiments, receiving information via a message template may comprise the module being further configured to automatically populate one or more information fields within the message template.

In some embodiments, receiving information via a message template may comprise the module being further configured to import information into one or more information fields within the message template.

In some embodiments, receiving information via a message template may comprise the module being further configured to import information into one or more information fields within the message template.

In some embodiments, receiving information via a message template may comprise the module being further configured to import information into one or more information fields within the message template.

In some embodiments, the message template comprises one or more items of required information, and the module is further configured to cause one or more computing processors to review the received information to verify that the one or more items of required information are valid, generate an error message in response to determining at least one item of required information is not valid, and prompt a user to provide valid information for the at least one item of required information.

In some embodiments, the message template comprises one or more items of required information, and wherein the module is further configured to cause one or more computing processors to review the received information to verify that the one or more items of required information have been provided, generate an error message in response to determining at least one item of required information has not been provided, and prompt a user to provide the at least one items of required information.

In some embodiments, automatically generate a message comprising the received information may comprise the module being further configured to export the received information within the message template to one or more messaging clients.

In some embodiments, sending the automatically generated message to one or more entities associated with the financial agreement may comprise the module being further configured to schedule when the automated message will be sent.

An exemplary method for use in financial systems, whereby the method provides steps for automatically generating messages based on message templates may comprise accessing a click to launch tool, wherein the click to launch tool is configured to automatically generate messages based at least partially on one or more message templates; selecting a message type presented within the click to launch tool, wherein the message type is associated with a selectable option indicating a type of message the click to launch tool is configured to generate; receiving information via a message template associated with the selected message type, wherein the receive information is related to a financial agreement; automatically generating a message associated with the selected message type, wherein the message comprises the received information; and sending the automatically generated message to one or more entities associated with the financial agreement.

In some embodiments, the method further comprises customizing the graphical user interface (GUI) associated with the click to launch tool presented on the computing device display of the user.

In some embodiments, the method further comprises joining one or more message templates in response to receiving a selection of an option to join the one or more message templates.

An exemplary computer program product for use in financial systems, whereby the computer program product automatically generates messages based on message templates may comprise a non-transitory computer-readable medium comprising a set of codes for causing a computer to access a click to launch tool, wherein the click to launch tool is configured to automatically generate messages based at least partially on one or more message templates; select a message type presented within the click to launch tool, wherein the message type is associated with a selectable option indicating a type of message the click to launch tool is configured to generate; receive information via a message template associated with the selected message type, wherein the receive information is related to a financial agreement; automatically generate a message associated with the selected message type, wherein the message comprises the received information; and send the automatically generated message to one or more entities associated with the financial agreement.

In some embodiments, the computer program product further comprises a set of codes for causing a computer to customize the graphical user interface (GUI) associated with the click to launch tool presented on the computing device display of the user.

### BRIEF DESCRIPTION OF THE DRAWINGS

Having thus described embodiments of the invention in general terms, reference will now be made to the accompanying drawings, where:

FIG. 1 is a high level process flow for a template-based automated message generation tool, in accordance with embodiments of the present invention;

FIG. 2 is a screenshot illustrating a user interface for a template-based automated message generation tool, in accordance with embodiments of the present invention;

FIG. 3 is a screenshot illustrating an introduction message template, in accordance with embodiments of the present invention;

FIG. 4 is a screenshot illustrating a renewal message, in accordance with embodiments of the present invention;

FIG. 5 is a screenshot illustrating a due diligence needs list template, in accordance with embodiments of the present invention;

FIG. 6 is a screenshot illustrating a due diligence needs list template, in accordance with embodiments of the present invention; and

FIG. 7 is a diagram illustrating a networking environment system, in accordance with embodiments of the present invention.

### DETAILED DESCRIPTION OF EMBODIMENTS OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

Embodiments of the invention are directed to systems, methods and computer program products that provide for automatically generated messages based on message templates. The invention enables a user to access a click to launch tool that is configured to automatically generate messages based at least partially on one or more message templates, and select a message type presented within the click to launch tool. The system may receive information via a message template associated with the selected message type and related to a financial agreement. A message comprising the received information is automatically generated and sent to one or more entities associated with the financial agreement.

In some embodiments, an “entity” may refer to a business entity that is either sending or receiving an automatically generated message. For example, in exemplary embodiments, an entity may be a financial institution, or one or more parties within the financial institution. For the purposes of this invention, a “financial institution” may be defined as any organization, entity, or the like in the business of moving, investing, or lending money, dealing in financial instruments, or providing financial services. This may include commercial banks, thrifts, federal and state savings banks, savings and loan associations, credit unions, investment companies, insurance companies and the like. In some embodiments, the entity may allow a customer to establish an account with the entity. An “account” may be the relationship that the customer has with the entity. Examples of accounts include a deposit account, such as a transactional account (e.g., a banking account), a savings account, an investment account, a money market account, a time deposit, a demand deposit, a pre-paid account, a credit account, a non-monetary customer profile that includes only personal information associated with the customer, or the like. The account is associated with and/or maintained by the entity. In other embodiments, an entity may not be a financial institution. In still other embodiments, the entity may be the merchant itself.

In some embodiments, the “customer” or “client” may be a customer (e.g., an account holder or a person who has an account (e.g., banking account, credit account, or the like) at the entity) or potential customer (e.g., a person who has submitted an application for an account, a person who is the target of marketing materials that are distributed by the entity, a person who applies for a loan that not yet been funded).

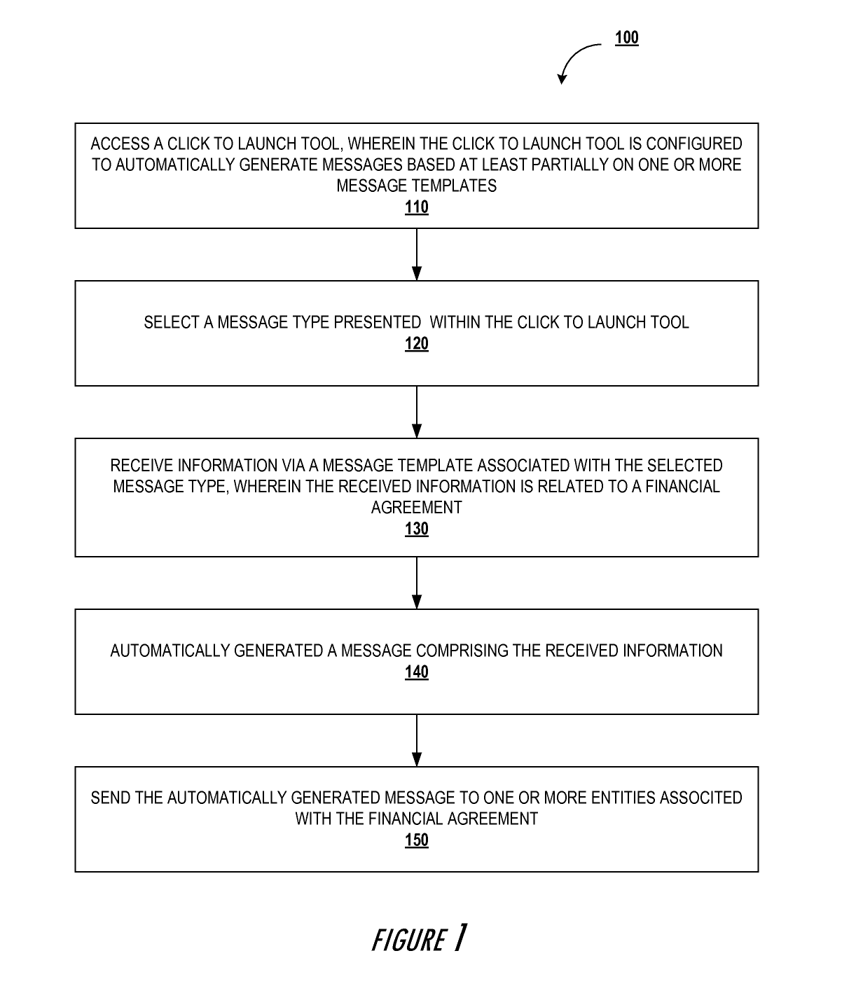

Referring now to FIG. 1, a high level process flow for providing a template-based message generation tool 100 is illustrated in accordance with one embodiment of the present invention, which will be discussed in further detail throughout this specification. As illustrated, the method may comprise a plurality of steps, including but not limited to, accessing a click to launch tool that is configured to automatically generate messages based at least partially on one or more message templates 110, selecting a message type presented within the click to launch tool 120, receiving information via a message template associated with the selected message type 130, automatically generating a message comprising the received information 140, and sending the automatically generated message to one or more entities associated with the financial agreement 150.

At step 110, the system may first access a click to launch message generation tool, where the click to launch message generation tool is configured to automatically generate messages based at least partially on one or more message templates. In some embodiments, accessing the click to launch message generation tool comprises receiving a user selection of an icon that deploys and/or executes a click to launch message generation program or tool for generating template-based messages in response to the selection of the icon. For example, the user may click an icon associated with the click to launch tool, and in response to clicking the icon the tool for generating automated template-based messages is executed on the user's computing device. Although, the tool for generating messaging templates is referred to herein as a “click to launch tool” or “click to launch message generation tool”, it should be also noted that the tool may be launched and/or executed using other methods such as voice commands, command line prompts, and the like. As such, the terms “click to launch tool” and “click to launch message generation tool” may be used interchangeably with general descriptive terms such as “tool” and “message generation tool”. For example, the click to launch tool may be launch in response to a voice command stating “run the click to launch tool” or “run the message generation tool”.

In some embodiments, accessing the click to launch tool may first comprise storing the click to launch tool in an accessible location or downloading the click to launch tool to one or more authorized devices. The click to launch tool may be executed on various devices including, but not limited to, personal computers, mobile devices, gaming devices, financial kiosk, and the like. In one embodiment, the click to launch tool is stored in a central location that is accessible by a plurality of authorized devices such as a business share drive. For example, a business entity may maintain a shared storage location, such as a shared drive or folder, that is accessible by one or more devices of authorized personnel within the business entity such that the one or more devices may access the shared storage location and execute the click to launch tool from the shared location. In another embodiment, the click to launch tool is individually downloaded to a plurality of authorized devices within the business entity such the authorized personnel may access the one or more devices and execute the click to launch tool from the authorized device.

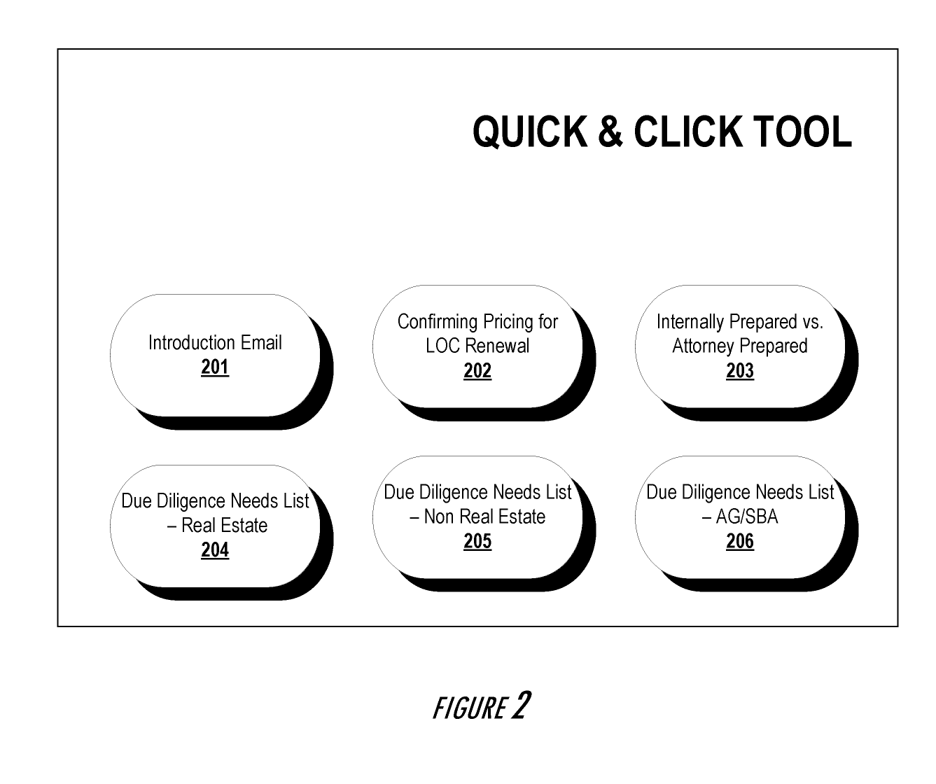

In some embodiments, as shown in FIG. 2, accessing the click to launch tool may further comprise presenting a graphical user interface (GUI) associated with the click to launch tool on a computing device of a user. A user may then be able to interact with the GUI for the purpose of utilizing various features of the click to launch tool. In this way, the GUI may comprise one or more options for selection, where the options may indicate message types that may be generated by the template-based message generation tool. For example, the options for selection may include, but not be limited to, introduction email 201, confirming pricing for letter of consent (LOC) renewal 202, internally prepared vs. attorney prepared 203, real estate due diligence needs list 204, non-real estate due diligence needs list 205, AG/SBA due diligence needs list 206, and the like.

In some embodiments, accessing the click to launch tool may further comprise customizing the GUI associated with the click to launch tool presented on a computing device of a user. In this way, the user may add and/or remove selectable options that are presented on the GUI based on the needs of the business as they potentially change. For example, a business entity may no longer offer non real estate financial agreements such that a user associated with the business entity may select to edit and remove the “due diligence needs list—non real estate” option and replace it with another option that is relevant to the needs of the business entity.

At step 120, after accessing the click to launch message generation tool, the system may select a message type presented within the click to launch tool. As previously discussed herein the message types may be presented as selectable options within the GUI associated with the message generation tool and presented on the user's computing device. The message types that may be generated by the message generation tool may include, but not be limited to, introduction email, confirming pricing for letter of consent (LOC) renewal, internally prepared vs. attorney prepared, real estate due diligence needs list, non-real estate due diligence needs list, AG/SBA due diligence needs list, and the like. In an exemplary embodiment, the message type is selected in response to receiving a user selection of an icon that is associated with a particular message type that the user wishes to generate a message for.

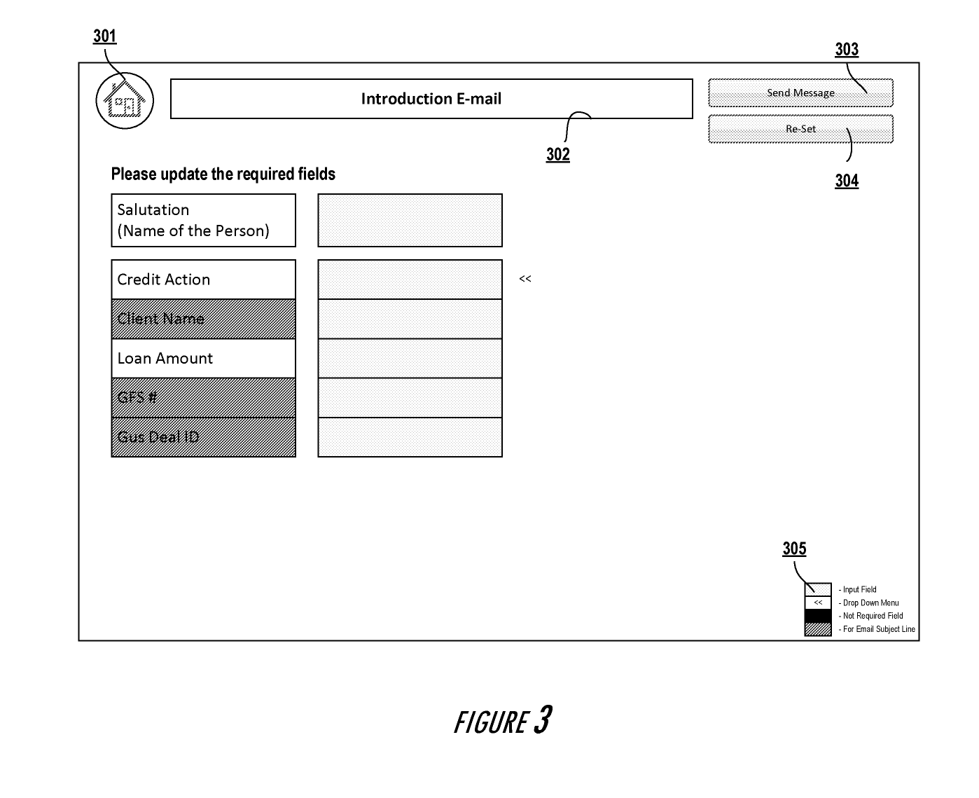

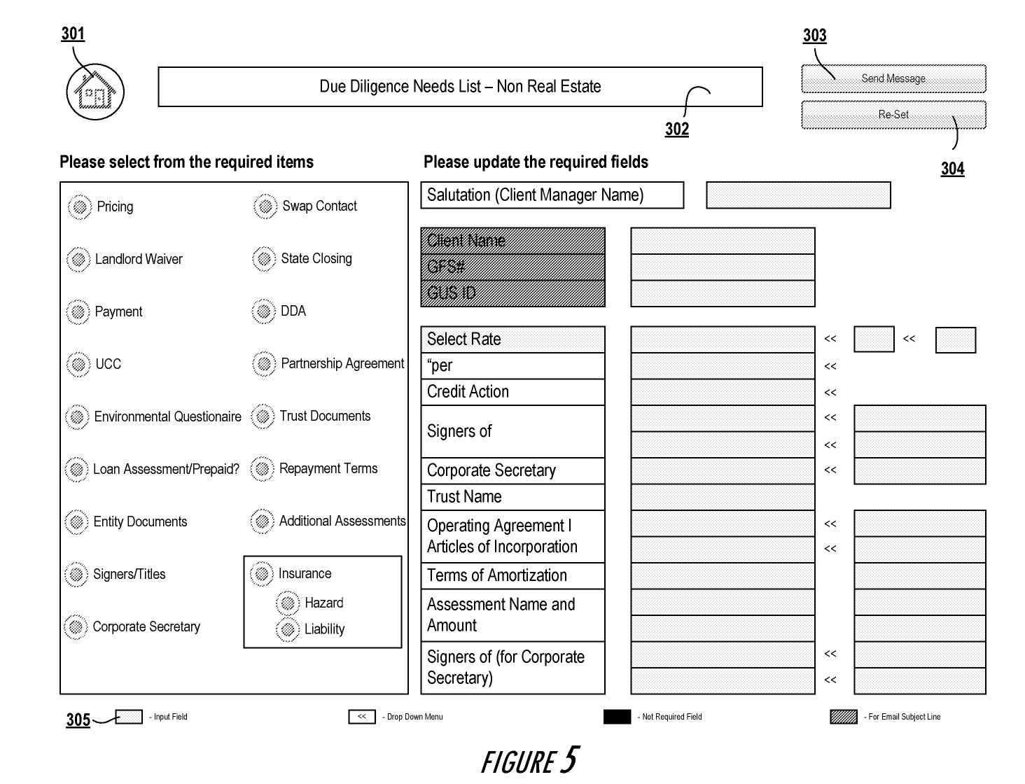

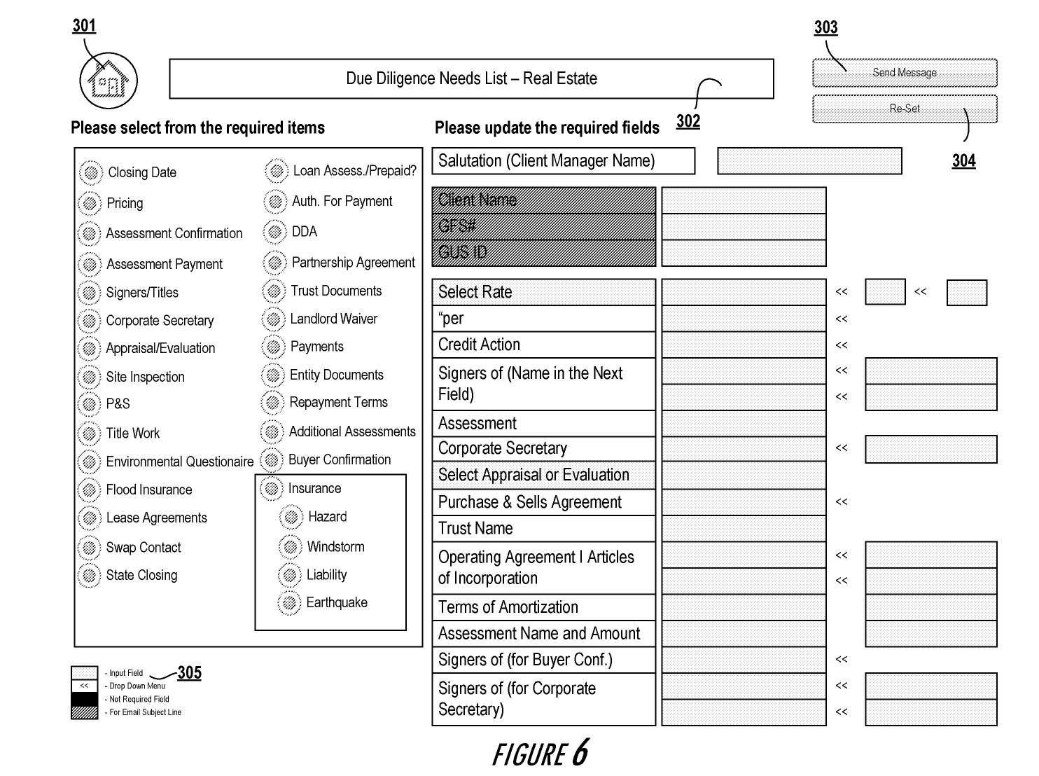

In some embodiments, selecting a message type presented within the click to launch tool may further comprise the system being configured to present on the user's computing device a message template associated with the selected message type. As shown in FIGS. 3-6, the message template(s) may comprise a home icon 301 that when selected allows a user to exit the current message template and return to the GUI home screen initially presented when executing click to launch message generation tool. The message template(s) may further comprise a template header 302 that indicates the type of message that was selected. The message template(s) may further comprise one or more buttons for selection (303, 304), including a button to send an automatically generated message 303 based on the information provided within the template, and a button to re-set the message template 304 such that any inputted content within the fields of the message template are cleared and/or restored to their initial state. The message template(s) may further comprise a legend to explain the fields presented for each message type. For example, the legend may define fields including, but not limited to, input fields, drop down menu fields, non-required fields, fields for use in creating an email subject line, and the like.

In some embodiments, the message type may comprise an introduction message. The introduction message template may include various input fields including, but not limited to, salutation (name of the person), credit action, client name, loan amount, government finance statistics (GFS) number, Guaranteed Underwriting system (Gus) Deal ID, and the like. As such the introduction message may be used for customers or completed financial packages related to customer that have recently acquired a new loan through the financial institution. In some embodiments, the introduction message template may be used in conjunction with a template for a second message type such that the introduction message provides introductory information associated with a completed package or related financial agreement and to be subsequently followed by or provided in addition to a second message type. In such an embodiment, the message generation tool may further comprise an option for selection to join one or more message templates.

In some embodiments, the message type may comprise a calculating pricing for letter or consent renewal message. The calculating pricing for letter or consent renewal message template may include various input fields including, but not limited to, salutation (name of the person), select rate option, “per, credit action, assessment, sent to, client name, government finance statistics (GFS) number, Guaranteed Underwriting system (Gus) Deal ID, and the like. As such the calculating pricing for letter or consent renewal message may be used for customers or completed financial packages related to customer that have recently completed a letter of consent through the financial institution. For example, a customer may complete a letter of consent to authorize a debit of their financial account, or granting an entity permission to act on their behalf.

In some embodiments, the message type may comprise a non-real estate due diligence needs list message. The non-real estate due diligence needs list message template may include various input fields for selecting required items within the completed package including, but not limited to, pricing, landlord waiver, payments, uniform commercial code (UCC), environmental questionnaire, loan assessment/prepaid?, entity documents, signer/titles, corporate secretary, swap contact, State 1 closing, due diligence act (DDA), partnership/agreement, trust documents, repayment terms, additional assessments, insurance (e.g. hazard and liability), and the like. In such an embodiment, the input field may be embodied by one or more radio buttons or selectable check mark boxes. The non-real estate due diligence needs list message template may further include various input fields for receiving user input information including, but not limited to, salutation (client manager name), client name, government finance statistics (GFS) number, Guaranteed Underwriting system (Gus) Deal ID, select rate option, “per, credit action, signers of, corporate secretary, trust name, operating agreement articles of incorporation, terms of amortization (in months), assessment name and amount, signers of (for corporate secretary), and the like. As such the non-real estate due diligence needs list message may be used for customers or completed financial packages related to customer that have recently completed a non-real estate agreement through the financial institution.

In some embodiments, the message type may comprise a real estate due diligence needs list message. The real estate due diligence needs list message template may include various input fields for selecting required items within the completed package including, but not limited to, closing date, pricing, assessment confirmation, assessment payment, signers/titles, corporate secretary, appraisal/evaluation, site inspection, purchase and sale statement (P&S), title work, environmental questionnaire, flood insurance, lease agreements, swap contact, State 1 closing, loan assessment/prepaid?, authorization for payoff, due diligence act (DDA), partnership agreement, trust documents, landlord waiver, payments, entity documents, repayment terms, additional assessments, buyer confirmation, insurance (e.g. hazard, windstorm, liability, and earthquake), and the like. In such an embodiment, the input field may be embodied by one or more radio buttons or selectable check mark boxes. The non-real estate due diligence needs list message template may further include various input fields for receiving user input information including, but not limited to, salutation (client manager name), client name, government finance statistics (GFS) number, Guaranteed Underwriting system (Gus) Deal ID, select rate option, “per, credit action, signers of (name in the next field), corporate secretary, select appraisal or evaluation, purchase and sells agreement, trust name, operating agreement articles of incorporation, terms of amortization (in months), assessment name and amount, signers of (for buyers confirmation field), signers of (for corporate secretary), and the like. As such the real estate due diligence needs list message may be used for customers or completed financial packages related to customer that have recently completed a real estate agreement through the financial institution.

At step 130, after selecting a message type presented within the click to launch tool, the system may be configured to receive information via a message template associated with the selected message type. In an exemplary embodiment, the message template is further associated with and/or related to a financial agreement on behalf of a client or customer of the financial institution. The received information may be directly inputted into the message template that is being presented on the user's computing device. The received information may typically be provided via one or more user input devices associated with the user's computing device. As previously discussed herein, the message template may indicate the type and/or categories of information that may be received, where a portion of the information may be required, and a portion of the information may be optional. Methods for receiving information may include, but not be limited to, manually inputting information into the message template using an input device, manually selection yes or no options using selectable input methods (e.g. radio buttons), and the like.

In some embodiments, receiving information via a message template may further comprise automatically populating one or more information fields within the message template. The fields may be populated based on one more standards or rules that are provided by the business entity responsible for maintaining the message generation tool. For example, the business entity may have static assessments that are assessed associated with real estate agreements. As such, the system may automatically populate any fields related to either assessments or assessment names with the static assessment amount and name. In another example, the business entity defines items that are required to be provided with real estate agreements. As such, the system may automatically select radio button options associated with items that are required to be provided with real estate agreements. In such an embodiment, the message generation tool may further comprise an option for selection to automatically populate one or more fields within a message template.

In some embodiments, receiving information via a message template may further comprise importing information into one or more information fields within the message template. The fields may be populated based on information that is available to the business entity and either stored locally or remotely accessible by the system for the purpose to importing the information into message templates. For example, a customer associated with the agreements processed through the financial intuition may possess a similar agreement that has been processed by the financial institution, where the terms and conditions have been stored and are accessible by the system. As such, the system may access the terms of the similar agreement and import at least portion of the information from the previous agreement into the current agreement.

In some embodiments, receiving information via a message template may further comprise for accuracy and completion. As shown in FIG. 3 through FIG. 6, the message templates may include several items of information, including but not limited to, salutation, client name, government finance statistics (GFS) number, Guaranteed Underwriting system (Gus) ID, and the like. The system may have pre-defined criteria for information that must be explicitly provided by the user such as the salutation and the client name. As such, the system may be further configured to review the received request to verify that each item of required information has been provided. In an instance where one or more items of required information are determined to be missing from the waiver request, the system may then be configured to present an error message (in an instance where the user attempts to send the message prior to providing the missing information) and further prompt the requesting entity provide the missing items of information prior to forwarding and/or sending the automatically generated message to the one or more entities associated with the financial agreement. The system may be further configured to review the received request to verify that each item of required information is accurate. For example, the system may verify that the inputted government finance statistics (GFS) number and Guaranteed Underwriting system (Gus) ID are parameters of valid accounts associated with the business entity. In an instance where one or more items of required information are determined to be invalid, the system may then be configured to present an error message (in an instance where the user attempts to send the message prior to valid information) and further prompt the requesting entity provide the missing items of information prior to forwarding and/or sending the automatically generated message to the one or more entities associated with the financial agreement.

At step 140, after receiving information via a message template associated with the selected message type, the system may then automatically generate a message comprising the received information. In some embodiments, automatically generating a message may comprise utilizing a message platform to format the message to be sent to a specific addressee or receiving entity. The platform may leverage formats or services such as post office protocol or message forwarding services for the purpose of generating and sending the template-based message. In some embodiments, automatically generating the message further comprises creating a message subject line based at least partially on the information specified in the message template to be necessary for creating the message subject line.

In some embodiments, automatically generate a message comprising the received information may further comprise the system being configured to export the information received within the message template to one or more messaging clients. In some embodiments, the system further exports a desired message format when exporting the received information such that the messaging client presents the information in a specific format when sending the message to the one or more entities associated with the financial agreement. For example, the specified format may indicate that the salutation and client names should be presented as headers, and the information associated with the radio buttons should be listed within the email. The format may additionally provide a template for generating the message, wherein the template indicated the message should initially read, for example, “Dear [Insert Salutation], please see attached information related to a due diligence need list concerning [Insert Client Name]. As such, empty fields within the formatted template may be populated in the messaging client using the information received in the message template of the message generation tool. In some embodiments, the information may be exported as a text file, html file, image file, and the like. For example, the received information may be exported to an email messaging client as a text file that additionally specifies a desired message format such that the email messaging client imports the information from the text file and presents the information within a email message according to the desired message format.

As step 150, the system may then send the automatically generated message to one or more entities associated with the financial agreement. In some embodiments, sending the automatically generated message to one or more entities associated with the financial agreement may comprise the system being further configured to schedule when the automated message will be sent. In such an embodiment the message templates may further comprise a “Send Later” button in addition to the “Send” button. In response to the selecting the send later button the user may be prompted to enter a date and time for scheduling the message to be sent such that the message is subsequently sent by the system on the scheduled date at the schedule time. In other embodiment, the automated messages may be sent in bulks at a prescheduled date and time as defined by the system user or the associated business entity. For example, the content of the information may be time sensitive, and a business entity may determine that customers and/or clients typically access their messages at a certain time of time such that the automated messages are scheduled to be sent each day at a prescheduled time.

In some embodiments, the system may be configured to send the automatically generated messaging using various methods. The methods of message transmission may include, but not be limited to, email messages, multimedia message, text messages, social networking messages, internal messages within online banking or other business entity platforms, and the like.

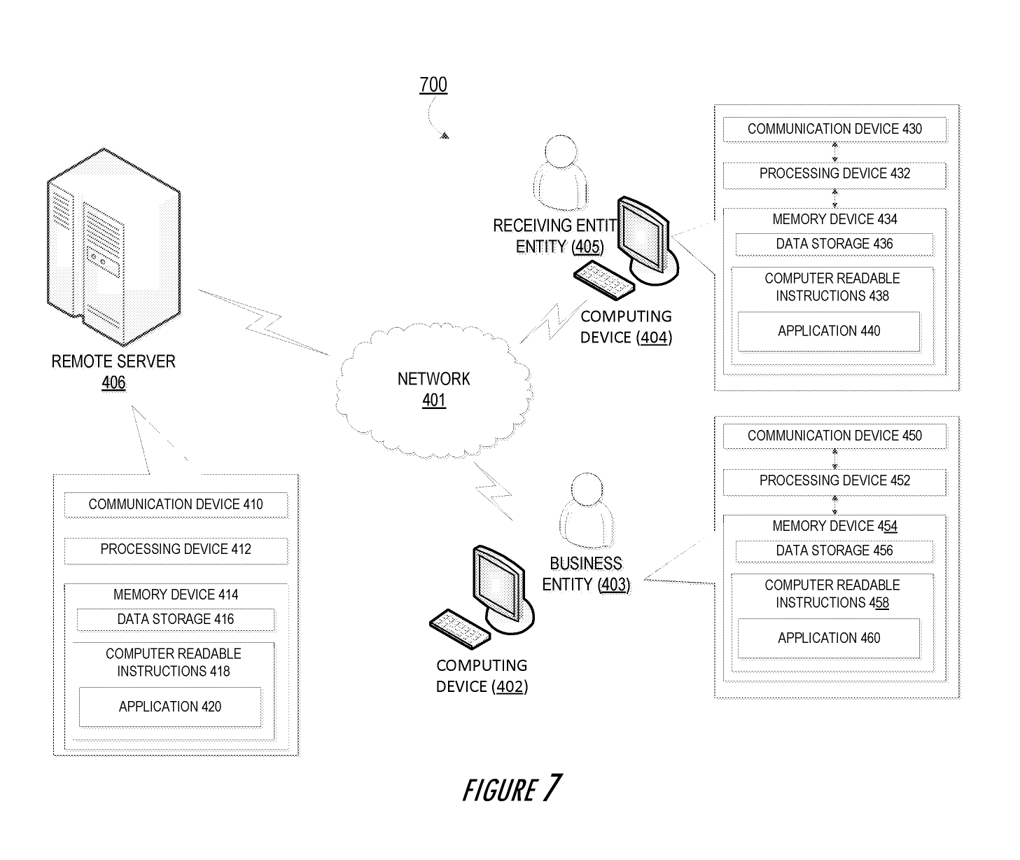

Referring to FIG. 7, a network environment 700 is illustrated in accordance with embodiments of the present invention. As illustrated in FIG. 7, the business entity computing device 402 is operatively coupled via a network 401 to the receiving entity computing device 404 and/or a remote server 406. In this configuration, the business entity computing device 402 may send information to and receive information from the receiving entity computing device 404 and/or the remote server 406. Additionally, the receiving entity computing device 404 may send and receive communications directly from the remote server 406. The business entity computing device 402 may be or include one or more network base stations or other network components. FIG. 7 illustrates only one example of an embodiment of a network environment 700, and it will be appreciated that in other embodiments one or more of the systems, devices, or servers may be combined into a single system, device, or server, or be made up of multiple systems, devices, or server.

The network 401 may be a global area network (GAN), such as the Internet, a wide area network (WAN), a local area network (LAN), a telecommunication network or any other type of network or combination of networks. The network 401 may provide for wire line, wireless, or a combination wire line and wireless communication between devices on the network 401.

In some embodiments, the receiving entity 405 is one or more entities associated with the financial agreement related to the generated message. In some embodiments, the business entity 403 is personnel within the related business that are responsible for providing the received information to be used in automatically generating the message.

As illustrated in FIG. 7, the business entity computing device 402 generally comprises a communication device 450, a processing device 452, and a memory device 454. As used herein, the term “processing device” generally includes circuitry used for implementing the communication and/or logic functions of the particular system. For example, a processing device may include a digital signal processor device, a microprocessor device, and various analog-to-digital converters, digital-to-analog converters, and other support circuits and/or combination of the foregoing. Control and signal processing functions of the system are allocated between these processing devices according to their respective capabilities. The processing device may include functionality to operate one or more software programs based on computer readable instructions thereof, which may be stored in a memory device.

The processing device 452 is operatively coupled to the communication device 450 to communicate with the network 401 and other devices on the network 401. As such, the communication device 450 generally comprises a modem, server, or other device for communicating with other devices on the network 401.

As further illustrated in FIG. 7, the network business entity computing device 402 comprises computer readable instructions 458 of an application 460. In some embodiments, the memory device, 454 includes data storage 456 for storing data related to and/or used by the application 460. The application 460 may perform one or more of the steps and/or sub-steps discussed herein and/or one or more steps not discussed herein. For example, in some embodiments, the application 460 may provide automatically generated messages to be communicated to one or more entities associated with the financial agreement.

As illustrated in FIG. 7, the receiving entity computing device 404 generally comprises a communication device 430, a processing device 432, a memory device 434, and a data storage device 436. The processing device 432 is operatively coupled to the communication device 430 and the memory device 434. In some embodiments, the processing device 432 may send or receive data from the receiving entity computing device 404, to the business entity computing device 402 via the communication device 430 over a network 401. As such, the communication device 430 generally comprises a modem, server, or other device for communicating with other devices on the network 401.

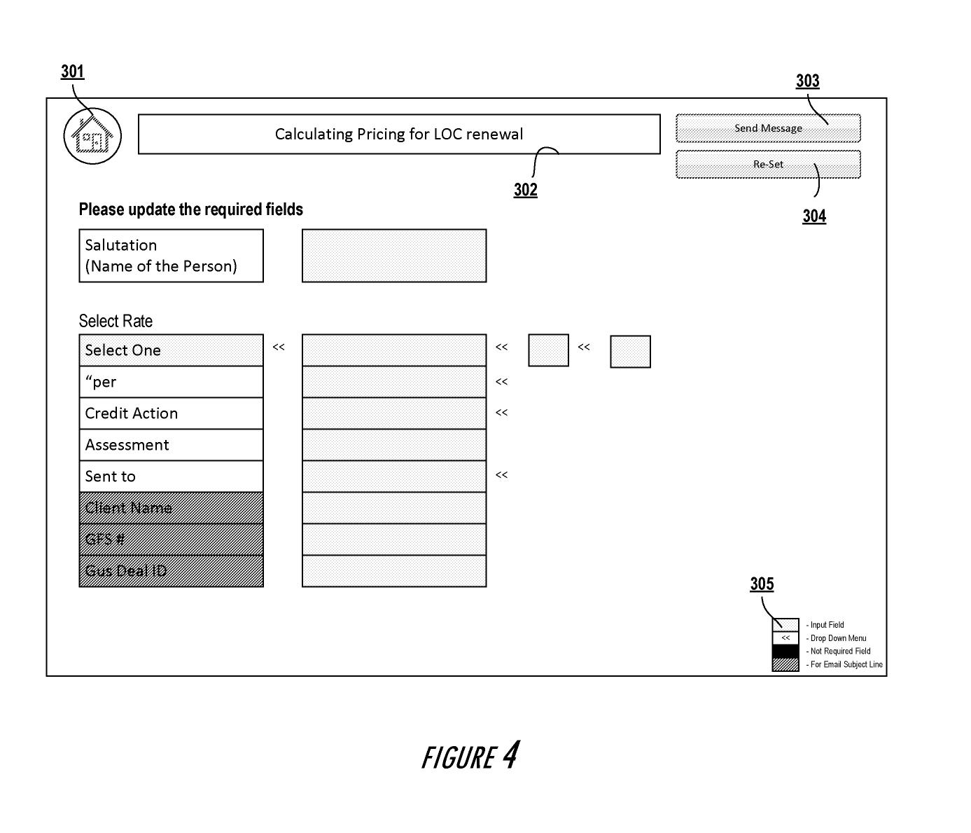

As further illustrated in FIG. 7, the receiving entity computing device 404 comprises computer readable instructions 438 stored in the memory device 434, which in one embodiment includes the computer-readable instructions 438 of an application 440. In the embodiment illustrated in FIG. 4, the application 440 allows the receiving entity computing device 404 to be linked to the business entity computing device 402 to communicate, via a network 401. The application 440 may also allow the receiving entity computing device 404 to connect directly (i.e. locally or device to device) with the remote server 406 for sending and receiving information. The application 440 may perform one or more of the steps and/or sub-steps discussed herein and/or one or more steps not discussed herein. For example, in some embodiments, the application 440 may send information for a waiver request.

As illustrated in FIG. 7, the remote server 406 may include a communication device 410, a processing device 412, a memory device 414, and a data storage device 416. The processing device 412 is operatively coupled to the communication device 410 and the memory device 414. In some embodiments, the processing device 412 may send or receive data from the receiving entity computing device 404 and/or the business entity computing device 402 via the communication device 410. Such communication may be performed either over a direct connection and/or over a network 401. As such, the communication device 410 generally comprises a modem, server, or other device for communication with other devices on the network 401.

As further illustrated in FIG. 7, the remote server 406 comprises computer-readable instructions 418 of an application 420. In the embodiment illustrated in FIG. 4, the application 420 allows the remote server 406 to be linked to the business entity computing device 402 to communicate, via a network 401. The application 420 may also allow the receiving entity computing device 404 to connect directly (i.e., locally or device to device) with the remote server 406 or indirectly through the network 401. The application 420 may perform one or more of the steps and/or sub-steps discussed herein and/or one or more steps not discussed herein.

Any of the features described herein with respect to a particular process flow are also applicable to any other process flow. In accordance with embodiments of the invention, the term “module” with respect to a system may refer to a hardware component of the system, a software component of the system, or a component of the system that includes both hardware and software. As used herein, a module may include one or more modules, where each module may reside in separate pieces of hardware or software.

Although many embodiments of the present invention have just been described above, the present invention may be embodied in many different forms and should not be construed as limited to the embodiments set forth herein; rather, these embodiments are provided so that this disclosure will satisfy applicable legal requirements. Also, it will be understood that, where possible, any of the advantages, features, functions, devices, and/or operational aspects of any of the embodiments of the present invention described and/or contemplated herein may be included in any of the other embodiments of the present invention described and/or contemplated herein, and/or vice versa. In addition, where possible, any terms expressed in the singular form herein are meant to also include the plural form and/or vice versa, unless explicitly stated otherwise. Accordingly, the terms “a” and/or “an” shall mean “one or more,” even though the phrase “one or more” is also used herein. Like numbers refer to like elements throughout.

As will be appreciated by one of ordinary skill in the art in view of this disclosure, the present invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the present invention may take the form of an entirely business method embodiment, an entirely software embodiment (including firmware, resident software, micro-code, stored procedures in a database, or the like), an entirely hardware embodiment, or an embodiment combining business method, software, and hardware aspects that may generally be referred to herein as a “system.” Furthermore, embodiments of the present invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device. In other embodiments of the present invention, however, the computer-readable medium may be transitory, such as, for example, a propagation signal including computer-executable program code portions embodied therein.

One or more computer-executable program code portions for carrying out operations of the present invention may include object-oriented, scripted, and/or unscripted programming languages, such as, for example, Java, Perl, Smalltalk, C++, SAS, SQL, Python, Objective C, JavaScript, and/or the like. In some embodiments, the one or more computer-executable program code portions for carrying out operations of embodiments of the present invention are written in conventional procedural programming languages, such as the “C” programming languages and/or similar programming languages. The computer program code may alternatively or additionally be written in one or more multi-paradigm programming languages, such as, for example, F#.

Some embodiments of the present invention are described herein with reference to flowchart illustrations and/or block diagrams of apparatus and/or methods. It will be understood that each block included in the flowchart illustrations and/or block diagrams, and/or combinations of blocks included in the flowchart illustrations and/or block diagrams, may be implemented by one or more computer-executable program code portions. These one or more computer-executable program code portions may be provided to a processor of a general purpose computer, special purpose computer, and/or some other programmable data processing apparatus in order to produce a particular machine, such that the one or more computer-executable program code portions, which execute via the processor of the computer and/or other programmable data processing apparatus, create mechanisms for implementing the steps and/or functions represented by the flowchart(s) and/or block diagram block(s).

The one or more computer-executable program code portions may be stored in a transitory and/or non-transitory computer-readable medium (e.g., a memory or the like) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the present invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. An apparatus for generating messages based on message templates in a financial institution system, the apparatus comprising:
a memory;
a computing processor; and
a module stored in the memory, said module comprising instruction code executable by one or more computing processors, and configured to cause the one or more computing processors to:
access a click to launch tool, wherein the click to launch tool is configured to automatically generate messages based at least partially on one or more message templates;
select a message type presented within the click to launch tool, wherein the message type is associated with a selectable option indicating a type of message the click to launch tool is configured to generate;
receive information via a message template associated with the selected message type, wherein the receive information is related to a financial agreement;
automatically generate a message associated with the selected message type, wherein the message comprises the received information; and
send the automatically generated message to one or more entities associated with the financial agreement.

2. The apparatus of claim 1, wherein the module is further configured to cause one or more computing processors to store the click to launch tool in a storage location that is accessible by one or more authorized user devices.

3. The apparatus of claim 1, wherein accessing the click to launch tool further comprises the module being configured to cause one or more computing processors to present a graphical user interface (GUI) associated with the click to launch tool on a computing device display of a user.

4. The apparatus of claim 3, wherein accessing the click to launch tool further comprises the module being configured to customize the graphical user interface (GUI) associated with the click to launch tool presented on the computing device display of the user based at least partially on user input.

5. The apparatus of claim 1, wherein selecting a message type presented within the click to launch tool further comprises the module being configured to present, on a display of a user's computing device, a message template associated with the selected message type.

6. The apparatus of claim 1, wherein the click to launch tool comprises an option to join one or more message templates, and wherein the module is further configured to join the one or more message templates in response to receiving a selection of the option to join one or more message templates.

7. The apparatus of claim 1, wherein the message type comprises at least one of an introduction message, a calculating pricing for letter or consent renewal message, a non-real estate due diligence needs list message, or a real estate due diligence needs list message.

8. The apparatus of claim 1, wherein receiving information via a message template comprises the module being further configured to automatically populate one or more information fields within the message template.

9. The apparatus of claim 1, wherein receiving information via a message template comprises the module being further configured to import information into one or more information fields within the message template.

10. The apparatus of claim 1, wherein receiving information via a message template comprises the module being further configured to import information into one or more information fields within the message template.

11. The apparatus of claim 1, wherein receiving information via a message template comprises the module being further configured to import information into one or more information fields within the message template.

12. The apparatus of claim 1, wherein the message template comprises one or more items of required information, and wherein the module is further configured to cause one or more computing processors to:
review the received information to verify that the one or more items of required information are valid;
generate an error message in response to determining at least one item of required information is not valid; and
prompt a user to provide valid information for the at least one item of required information.

13. The apparatus of claim 1, wherein the message template comprises one or more items of required information, and wherein the module is further configured to cause one or more computing processors to:
review the received information to verify that the one or more items of required information have been provided;
generate an error message in response to determining at least one item of required information has not been provided; and
prompt a user to provide the at least one items of required information.

14. The apparatus of claim 1, wherein automatically generate a message comprising the received information comprises the module being further configured to export the received information within the message template to one or more messaging clients.

15. The apparatus of claim 1, wherein sending the automatically generated message to one or more entities associated with the financial agreement comprises the module being further configured to schedule when the automated message will be sent.

16. A method for use in financial systems, whereby the method provides steps for automatically generating messages based on message templates, the method comprising:
accessing a click to launch tool, wherein the click to launch tool is configured to automatically generate messages based at least partially on one or more message templates;
selecting a message type presented within the click to launch tool, wherein the message type is associated with a selectable option indicating a type of message the click to launch tool is configured to generate;
receiving information via a message template associated with the selected message type, wherein the receive information is related to a financial agreement;
automatically generating a message associated with the selected message type, wherein the message comprises the received information; and
sending the automatically generated message to one or more entities associated with the financial agreement.

17. The method of claim 16, wherein the method further comprises customizing the graphical user interface (GUI) associated with the click to launch tool presented on the computing device display of the user based at least partially on user input.

18. The method of claim 16, wherein the method further comprises joining one or more message templates in response to receiving a selection of an option to join the one or more message templates.

19. A computer program product for use in financial systems, whereby the computer program product automatically generates messages based on message templates, the computer program product comprising:
a non-transitory computer-readable medium comprising a set of codes for causing a computer to:
access a click to launch tool, wherein the click to launch tool is configured to automatically generate messages based at least partially on one or more message templates;
select a message type presented within the click to launch tool, wherein the message type is associated with a selectable option indicating a type of message the click to launch tool is configured to generate;
receive information via a message template associated with the selected message type, wherein the receive information is related to a financial agreement;
automatically generate a message associated with the selected message type, wherein the message comprises the received information; and
send the automatically generated message to one or more entities associated with the financial agreement.

20. The computer program product of claim 19, the computer program product further comprises a set of codes for causing a computer to customize the graphical user interface (GUI) associated with the click to launch tool presented on the computing device display of the user based at least partially on user input.
